(19) United States
(12) Patent Application Publication
(10) Pub. No.: US 2008/0091700 A1
(43) Pub. Date: Apr. 17, 2008

(54) Network-based document generation and processing

(76) Inventors: Bradley R. Brotherson, Las Vegas, NV (US); Aaron Romano, Henderson, NV (US); John C. Toftey, Henderson, NV (US)

Correspondence Address: Noblitt & Gilmore, LLC;Suite 6000, 4800 North Scottsdale Road, Scottsdale, AZ, 85251, US

(21) Appl. No.: 11/444,291

(22) Filed: May 30, 2006

Related U.S. Application Data
(60) Provisional application No. 60/686,537, filed on May 31, 2005.

(51) Int. Cl. G06F 17/30

(52) U.S. Cl. 707/102; 707/E17.008

(57) ABSTRACT

Methods and apparatus for network-based document generation and processing generally include bulk document processing via a document generation service. The document generation service may be configured to generate securities-related and/or insurance-related documents.

### CROSS REFERENCES TO RELATED APPLICATIONS

This application claims the benefit of U.S. Provisional Patent Application No. 60/686,537 filed 31 May 2005 and incorporates the disclosure of that application by reference.

### FIELD

Techniques and tools for network-based document generation and processing are described. For example, a user uploads a data set to a Web-based document generation service, which analyzes the data set and prepares multiple documents from the data set and one or more document templates.

### REFERENCE TO COMPUTER PROGRAM LISTING APPENDIX

Two compact discs (one original, one duplicate) are submitted herewith. The two compact discs are identical. Each disc contains computer program listings in compliance with 37 CFR §§ 1.52(e), 1.77(b)(4), and 1.96. The discs are formatted for use in Microsoft Corporation's Windows XP operating system on an IBM-PC.

The material on the two compact discs is hereby incorporated by reference. The names, creation dates, and sizes (in bytes) of the files (incorporated by reference) on the discs are:

| | date of | size |
|---|---|---|
| name of file | creation | (in bytes) |
| Classes\Code\ADAC\ADAC.txt | May 27, 2005 | 121,926 |
| Classes\Code\ASecurity\Cypher.txt | May 27, 2005 | 2,970 |
| Classes\Code\Entities\Orgs.text | May 27, 2005 | 13,017 |
| Classes\Code\Entities\Users.text | May 27, 2005 | 29,579 |
| Classes\Code\TRFormObject\RenderFormControl.txt | May 27, 2005 | 41,230 |
| Database\TitleRight.sql | May 10, 2005 | 182,396 |
| PrintEngine\Code\MainForm.txt | May 27, 2005 | 9,011 |
| PrintEngine\Code\clsDocuments.txt | May 27, 2005 | 22,088 |
| PrintEngine\Code\clsQue.txt | May 27, 2005 | 1,943 |
| RenderFormControl\RenderFormControl.txt | May 27, 2005 | 43,541 |
| TRManager\Code\AppConfig.txt | May 27, 2005 | 448 |
| TRManager\Code\frmMain.txt | May 27, 2005 | 147,288 |
| TitleRight\Code\AccountAdmin\AccountAdminFrame.txt | May 27, 2005 | 1,079 |
| TitleRight\Code\AccountAdmin\AccountAdminTopBar.aspx.txt | May 27, 2005 | 691 |
| TitleRight\Code\AccountAdmin\AccountAdminTopBar.txt | May 27, 2005 | 1,365 |
| TitleRight\Code\AccountAdmin\ChangePassword.aspx.txt | May 27, 2005 | 3,086 |
| TitleRight\Code\AccountAdmin\ChangePassword.txt | May 27, 2005 | 3,877 |
| TitleRight\Code\AccountAdmin\LeftNav.aspx.txt | May 27, 2005 | 2,755 |
| TitleRight\Code\AccountAdmin\LeftNav.txt | May 27, 2005 | 2,788 |
| TitleRight\Code\AccountAdmin\LeftNavFrame.txt | May 27, 2005 | 789 |
| TitleRight\Code\AccountAdmin\OrgAndUserFrame.txt | May 27, 2005 | 902 |
| TitleRight\Code\AccountAdmin\frmClientData.aspx.txt | May 27, 2005 | 9,841 |
| TitleRight\Code\AccountAdmin\frmClientData.txt | May 27, 2005 | 15,972 |
| TitleRight\Code\AccountAdmin\frmClientOrg.aspx.txt | May 27, 2005 | 6,347 |
| TitleRight\Code\AccountAdmin\frmClientOrg.txt | May 27, 2005 | 8,575 |
| TitleRight\Code\AccountAdmin\frmManageOrg.aspx.txt | May 27, 2005 | 3,302 |
| TitleRight\Code\AccountAdmin\frmManageOrg.txt | May 27, 2005 | 2,950 |
| TitleRight\Code\AccountAdmin\frmOrgData.aspx.txt | May 27, 2005 | 12,405 |
| TitleRight\Code\AccountAdmin\frmOrgData.txt | May 27, 2005 | 10,453 |
| TitleRight\Code\AccountAdmin\frmUserData.aspx.txt | May 27, 2005 | 13,953 |
| TitleRight\Code\DocProcessing\Checkout.aspx.txt | May 27, 2005 | 6,075 |
| TitleRight\Code\DocProcessing\Checkout.txt | May 27, 2005 | 2,129 |
| TitleRight\Code\DocProcessing\DocGen.aspx.txt | May 27, 2005 | 3,924 |
| TitleRight\Code\DocProcessing\DocGen.txt | May 27, 2005 | 934 |
| TitleRight\Code\DocProcessing\DocProcessingFrame.txt | May 27, 2005 | 1,034 |
| TitleRight\Code\DocProcessing\DocProcessingTopBar.aspx.txt | May 27, 2005 | 1,235 |
| TitleRight\Code\DocProcessing\DocProcessingTopBar.txt | May 27, 2005 | 2,088 |
| TitleRight\Code\DocProcessing\DocQue.aspx.txt | May 27, 2005 | 4,796 |
| TitleRight\Code\DocProcessing\DocQue.txt | May 27, 2005 | 2,332 |
| TitleRight\Code\DocProcessing\DocSelection.aspx.txt | May 27, 2005 | 23,350 |
| TitleRight\Code\DocProcessing\DocSelection.txt | May 27, 2005 | 9,407 |
| TitleRight\Code\DocProcessing\DocSelectionTopBar.aspx.txt | May 27, 2005 | 1,156 |
| TitleRight\Code\DocProcessing\DocSelectionTopBar.txt | May 27, 2005 | 1,371 |
| TitleRight\Code\DocProcessing\LeftNav.txt | May 27, 2005 | 1,323 |
| TitleRight\Code\DocProcessing\LeftNavLinks.txt | May 27, 2005 | 1,346 |
| TitleRight\Code\DocProcessing\OrderQue.aspx.txt | May 27, 2005 | 8,291 |
| TitleRight\Code\DocProcessing\OrderQue.txt | May 27, 2005 | 4,678 |
| TitleRight\Code\DocProcessing\frmInLine.aspx.txt | May 27, 2005 | 1,679 |
| TitleRight\Code\DocProcessing\frmInLine.txt | May 27, 2005 | 1,370 |
| TitleRight\Code\DocProcessing\frmTopDown.aspx.txt | May 27, 2005 | 1,927 |
| TitleRight\Code\DocProcessing\frmTopDown.txt | May 27, 2005 | 1,417 |
| TitleRight\Code\Evictions\DocProcessingFrame.txt | May 27, 2005 | 1,065 |
| TitleRight\Code\Evictions\DocQueHeader.txt | May 27, 2005 | 640 |
| TitleRight\Code\Evictions\EVCheckout.aspx.txt | May 27, 2005 | 6,015 |
| TitleRight\Code\Evictions\EVCheckout.txt | May 27, 2005 | 2,132 |
| TitleRight\Code\Evictions\EVDocGen.aspx.txt | May 27, 2005 | 3,928 |
| TitleRight\Code\Evictions\EVDocGen.txt | May 27, 2005 | 934 |
| TitleRight\Code\Evictions\EVDocProcessingTopBar.aspx.txt | May 27, 2005 | 1,230 |
| TitleRight\Code\Evictions\EVDocProcessingTopBar.txt | May 27, 2005 | 2,088 |
| TitleRight\Code\Evictions\EVDocQue.aspx.txt | May 27, 2005 | 3,483 |
| TitleRight\Code\Evictions\EVDocQue.txt | May 27, 2005 | 1,897 |
| TitleRight\Code\Evictions\EVDocSelection.aspx.txt | May 27, 2005 | 23,095 |
| TitleRight\Code\Evictions\EVDocSelection.txt | May 27, 2005 | 9,332 |
| TitleRight\Code\Evictions\EVDocSelectionMulti.aspx.txt | May 27, 2005 | 18,145 |
| TitleRight\Code\Evictions\EVDocSelection.Multi.txt | May 27, 2005 | 7,244 |
| TitleRight\Code\Evictions\EVDocSelectionTopBar.aspx.txt | May 27, 2005 | 1,156 |
| TitleRight\Code\Evictions\EVDocSelectionTopBar.txt | May 27, 2005 | 2,212 |
| TitleRight\Code\Evictions\EVOrderQue.aspx.txt | May 27, 2005 | 7,720 |
| TitleRight\Code\Evictions\EVOrderQue.txt | May 27, 2005 | 5,060 |
| TitleRight\Code\Evictions\EVfrmInLine.aspx.txt | May 27, 2005 | 1,715 |
| TitleRight\Code\Evictions\EVfrmInLine.txt | May 27, 2005 | 1,706 |
| TitleRight\Code\Evictions\EVfrmTopDown.aspx.txt | May 27, 2005 | 1,238 |
| TitleRight\Code\Evictions\EVfrmTopDown.txt | May 27, 2005 | 1,715 |
| TitleRight\Code\Evictions\LeftNav.txt | May 27, 2005 | 1,310 |
| TitleRight\Code\Evictions\LeftNavLinks.txt | May 27, 2005 | 1,342 |
| TitleRight\Code\Evictions\OrderQueHeader.txt | May 27, 2005 | 1,629 |
| TitleRight\Code\Navigation\AccountAdminHeader.txt | May 27, 2005 | 870 |
| TitleRight\Code\Navigation\DocQueHeader.txt | May 27, 2005 | 634 |
| TitleRight\Code\Navigation\OrderQueHeader.aspx.txt | May 27, 2005 | 1,184 |
| TitleRight\Code\Navigation\OrderQueHeader.txt | May 27, 2005 | 2,021 |
| TitleRight\Code\Navigation\TrackingHeader.txt | May 27, 2005 | 862 |
| TitleRight\Code\Root\AboutUs.txt | May 27, 2005 | 4,038 |
| TitleRight\Code\Root\AcceptCond.aspx.txt | May 27, 2005 | 1,443 |
| TitleRight\Code\Root\AcceptCond.txt | May 27, 2005 | 30,975 |
| TitleRight\Code\Root\ContactUs.txt | May 27, 2005 | 3,831 |
| TitleRight\Code\Root\Default.txt | May 27, 2005 | 4,838 |
| TitleRight\Code\Root\Demo.txt | May 27, 2005 | 3,713 |
| TitleRight\Code\Root\RightBarLogin.ascx.txt | May 27, 2005 | 5,530 |
| TitleRight\Code\Root\RightBarLogin.txt | May 27, 2005 | 2,512 |
| TitleRight\Code\Root\conditions.txt | May 27, 2005 | 29,640 |
| TitleRight\Code\Tracking\LeftNavFrame.txt | May 27, 2005 | 792 |
| TitleRight\Code\Tracking\TrackingFrame.txt | May 27, 2005 | 1,057 |
| TitleRight\Code\Tracking\TrackingLeftNav.aspx.txt | May 27, 2005 | 2,759 |
| TitleRight\Code\Tracking\TrackingLeftNav.txt | May 27, 2005 | 2,968 |
| TitleRight\Code\Tracking\TrackingTopBar.aspx.txt | May 27, 2005 | 1,140 |
| TitleRight\Code\Tracking\frmOrders.aspx.txt | May 27, 2005 | 12,842 |
| TitleRight\Code\Tracking\frmOrders.txt | May 27, 2005 | 6,045 |
| TitleRight\Code\Tracking\frmQA.aspx.txt | May 27, 2005 | 7,820 |
| TitleRight\Code\Tracking\frmQA.txt | May 27, 2005 | 4,529 |
| WebService\Client\Code\AssemblyInfo.txt | May 27, 2005 | 1,276 |
| WebService\Client\Code\Login.txt | May 27, 2005 | 6,196 |
| WebService\Client\Code\Reference.txt | May 27, 2005 | 12,331 |
| WebService\Client\Code\ReferenceMap.txt | May 27, 2005 | 513 |
| WebService\Client\Code\Sub Main.txt | May 27, 2005 | 806 |
| WebService\Client\Code\TRExporterCode.txt | May 27, 2005 | 52,735 |
| WebService\Client\Code\datatransWSDL.txt | May 27, 2005 | 12,758 |
| WebService\WebService\DataTrans.asmx.txt | May 27, 2005 | 22,653 |

### SUMMARY

The document generation and processing tools and techniques described herein include numerous innovative aspects. Various innovative aspects described herein may be used together in various combinations. Or, each of the various innovative aspects may be used separately or in combination with other techniques and tools.

According to some innovative aspects of the techniques and tools described herein, a document generation service provides bulk document processing. The bulk document processing allows a user to prepare multiple documents as a batch, greatly simplifying the creation process for batches of documents.

According to other innovative aspects of the techniques and tools described herein, a document generation service provides single document processing through an intuitive and easy-to-use user interface as described herein. Various innovative features of the user interface organization and navigation described herein facilitate document generation.

According to other innovative aspects of the techniques and tools described herein, a document generation service generates forms for in-line data entry. This facilitates the data entry and/or review processes in some scenarios by presenting user input data in the context of document material. For example, a Web service dynamically generates an in-line HTML form from a specification of the controls, text, and line breaks for a document.

According to other innovative aspects of the techniques and tools described herein, a document generation service generates forms for top-down data entry. This facilitates the data entry and/or review processes in some scenarios by presenting user input data in a straightforward manner, facilitating data entry or review by persons already very familiar with the content of a document. For example, a Web service dynamically generates a top-down HTML form from a specification of the controls and field labels for a document.

According to other innovative aspects of the techniques and tools described herein, a document generation service generates jurisdiction-specific forms for real estate transactions or other transactions. For example, the service provides multiple levels of jurisdiction selections for documents (e.g., state, county, city).

According to other innovative aspects of the techniques and tools described herein, a document generation service incorporates business rules or other constraints to associate one or more dependent documents with a main document to be created. This helps an end user by providing related documents (or at least reminding the end user about related documents) that are needed or suggested to complete a transaction.

According to other innovative aspects of the techniques and tools described herein, a plug-in or other software interfaces between a document generation service and a custom or third-party data source. Such interface software facilitates use and adoption of the document generation service.

According to other innovative aspects of the techniques and tools described herein, a tracking and/or searching engine provides services to end users. For example, the engine provides services to track real estate documents from creation through distribution and recording. Or, the engine provides search services to persons reviewing documents for compliance with regulations, reuse of forms, or information about past transactions. Or, the engine provides report production services for various purposes. These tracking and/or searching services leverage the information aggregated for document generation purposes for other valuable purposes, or the tracking and/or searching services are provided separately.

According to other innovative aspects of the techniques and tools described herein, the document generation, tracking, and/or searching services are applied in the area of securities transactions. For example, such services can greatly simplify the paperwork for complex securities transactions. A document generation service can incorporate business rules or other regulations at various states to help ensure compliance with regulations or best practices of an organization. Organizations can use tracking and/or search services for compliance monitoring or other analysis. Various other features (e.g., bulk uploading, user interface features, interface software) further facilitate use and adoption of the services in the area of securities transactions.

According to other innovative aspects of the techniques and tools described herein, the document generation, tracking, and/or searching services are applied in the area of insurance transactions. For example, such services can greatly simplify the paperwork for complex insurance transactions. Such services can include many of the same features as in the area of securities transactions.

According to other innovative aspects of the techniques and tools described herein, the document generation, tracking, and/or searching services are applied in the area of property management. For example, the services are used for eviction forms. Various features can reduce costs and simplify the document generation process for property management documents, including bulk document process for multiple tenants, data reuse, and interfacing with electronic filing systems. Account information can be used to streamline and simplify the document generation process. Various tracking and search features provide information to property managers and other users in a timely manner.

According to other innovative aspects of the techniques and tools described herein, form maintenance/generation software facilitates the specification and maintenance of forms.

According to other innovative aspects of the techniques and tools described herein, a print engine facilitates final document creation.

The preceding list of innovative aspects of the techniques and tools described herein is merely illustrative; it is not an exhaustive list. The foregoing and other objects, features, and advantages of the invention will become more apparent from the following detailed description, which proceeds with reference to the accompanying figures.

### BRIEF DESCRIPTION OF THE DRAWINGS

FIG. 1 is a block diagram showing an example computing environment in which the techniques and tools described herein may be implemented.

FIG. 2 is a diagram showing an example network architecture for Web-based document generation.

FIG. 3A is a diagram showing an example server-side system architecture.

FIG. 3B is a diagram showing example software and hardware specifications for the system architecture of FIG. 3A.

FIGS. 4A through 4H are flow diagrams showing an example user interface for navigation for various innovative services, business processes, and technical features.

FIGS. 5A through 5C are flow charts showing an example Web server form generation process.

FIG. 6 is a flow chart showing an example final document completion process.

### DETAILED DESCRIPTION

### I. Example Computing Environment

The techniques and tools described herein can be implemented on any of a variety of computing devices and environments, including computers of various form factors (personal, workstation, server, handheld, laptop, tablet, or other mobile) communicating across computing networks such as the World Wide Web. The described tools and techniques can be implemented in hardware circuitry, as well as in software (180) executing within a computer or other computing environment, such as shown in FIG. 1.

FIG. 1 illustrates a generalized example of a suitable computing environment (100) in which the described techniques and tools can be implemented. The computing environment (100) is not intended to suggest any limitation as to scope of use or functionality of the tools and techniques described herein, as they may be implemented in diverse general-purpose or special-purpose computing environments.

With reference to FIG. 1, the computing environment (100) includes at least one processing unit (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory, etc.), or some combination of the two. The memory (120) stores software (180) implementing operations for one side (e.g., client-side, server-side) of the techniques and tools described herein.

A computing environment may have additional features. For example, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and includes magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) (e.g., for devices operating as a control point in the device connectivity architecture) may be a touch input device such as a keyboard, mouse, pen, or trackball, a voice input device, a scanning device, or another device that provides input to the computing environment (100). The output device(s) (160) may be a display, printer, speaker, CD-writer, or another device that provides output from the computing environment (100).

The communication connection(s) (170) enable communication over a communication medium to another computing entity. The communication medium conveys information such as computer-executable instructions or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The software herein can be described in the general context of computer-readable media. Computer-readable media are any available media that can be accessed within a computing environment. By way of example, and not limitation, with the computing environment (100), computer-readable media include memory (120), storage (140), communication media, and combinations of any of the above.

The techniques herein can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. For the sake of presentation, the detailed description uses terms like “determine,” “generate,” “adjust,” and “apply” to describe computer operations in a computing environment. These terms are high-level abstractions for operations performed by a computer, and should not be confused with acts performed by a human being. The actual computer operations corresponding to these terms vary depending on implementation.

### II. Example Architecture for Web-based Document Generation

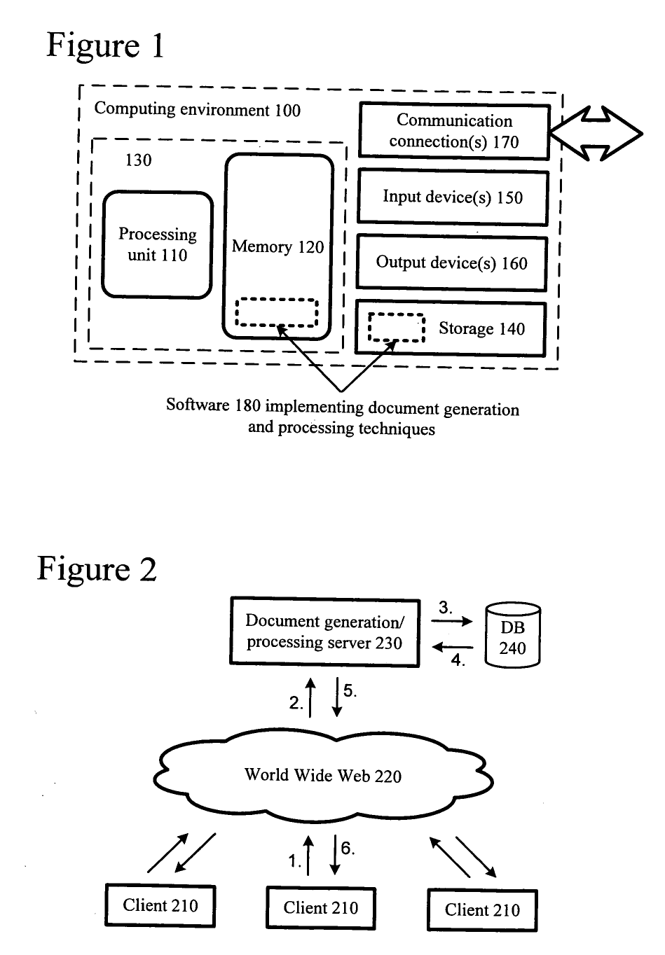

FIG. 2 shows an example network architecture (200) for a Web-based document generation and processing service. The components of the system (200) include multiple clients (210) that communicate over the World Wide Web (220) with a document generation/processing server (230).

The client (210) is a computing device for an end user or customer of a Web-based document generation and processing service. The client (210) is implemented, for example, with the components in a computing environment (100) as shown in FIG. 1. For Web-based interaction, the client (210) includes a Web browser as well as document processing software such as a word processor (e.g., MS Word), spreadsheet (e.g. MS Excel) and image processor (e.g., Adobe Acrobat). Alternatively, the client (210) includes other and/or additional software. For example, the client (210) includes customized application software for navigating to, interacting with, and processing results from the server (230), or the client (210) includes customized software for interfacing between the server (230) and specialized software for a particular industry.

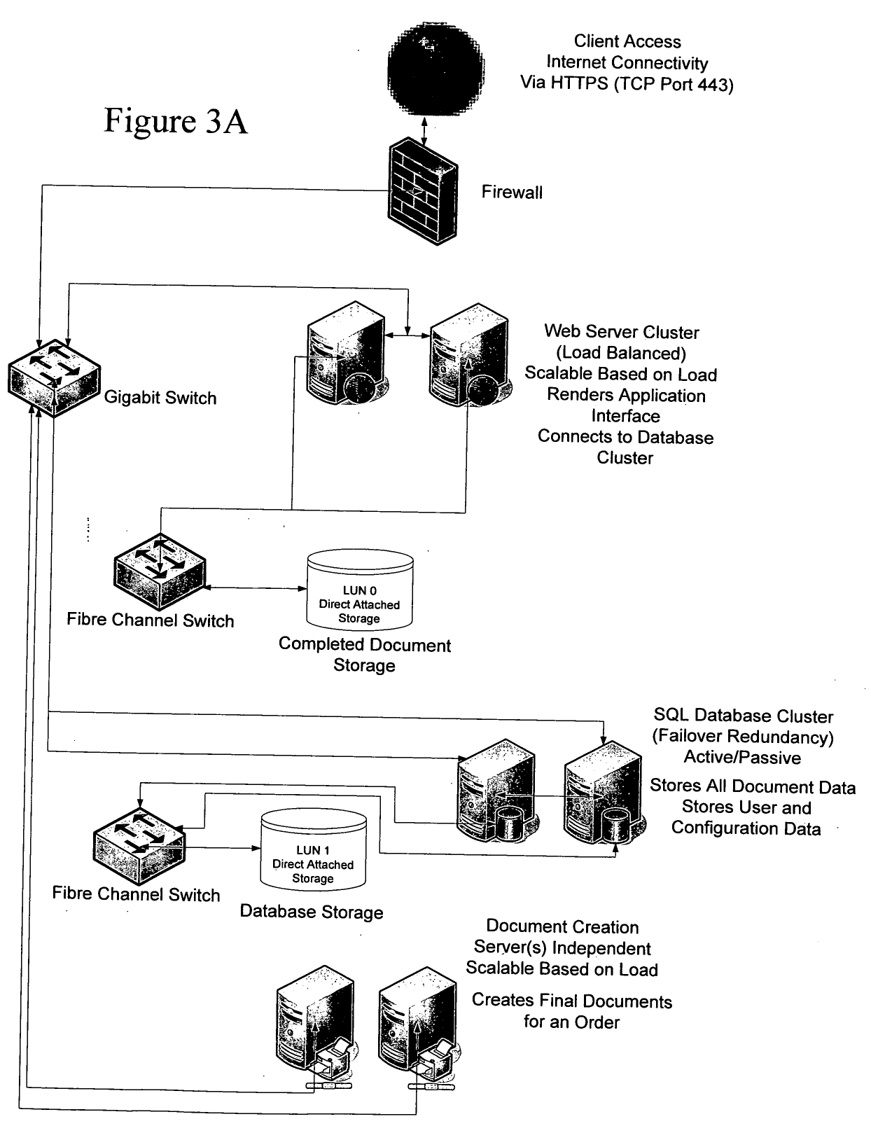

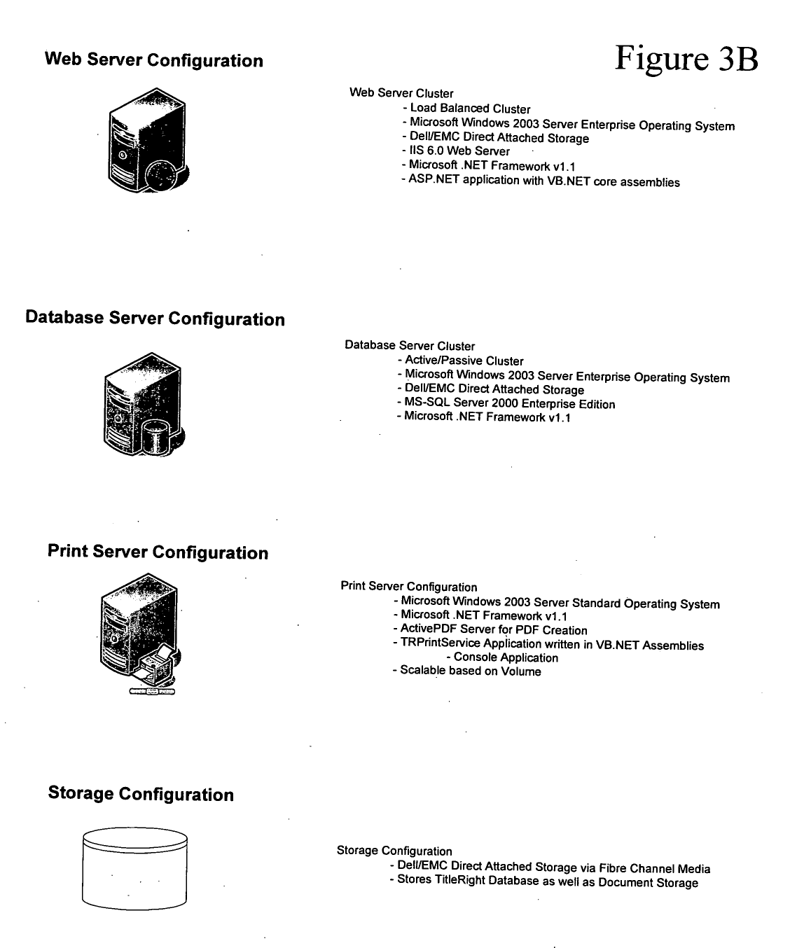

The server (230) is a computing device that exposes the Web-based document generation and processing service to one or more clients (210). The server (230) is implemented, for example, with the components in a computing environment (100) as shown in FIG. 1. For Web-based interaction, the server (230) includes a Web server as well as document processing software (such as a word processor, spreadsheet, and image processor) and software for communicating with a database (240) storing templates, forms, and other material incorporated into documents. Alternatively, the server (230) includes other and/or additional software. Although FIG. 2 shows a single server (230), in many cases the server (230) is in fact implemented across multiple server-side computing devices (see, e.g., FIGS. 3A and 3B). Similarly, the database (240) may be implemented across multiple computing devices at the same physical location(s) as the servers or different physical locations (connected by network(s)).

FIG. 2 shows a Web-based system (200) in which components communicate using some variant of HTTP. Alternatively, the components of the system communicate using another protocol over the Internet or another network.

In general, a client (210) locates the server (230) and establishes one or more connections with the server (230) over the Web (220). The server (230) transmits information for one or more Web pages to the client (210), which processes and renders the one or more Web pages. The client (210), for example, in reaction to user input, requests additional information from the server (230) so as to navigate among Web pages.

For example, through a series of interactions, the client (210) navigates to the server (230) and identifies the document or documents to be created. The document(s) are then generated and processed as follows.

1. The client (210) uploads or otherwise provides data to the server (230) for the document(s).

2. The server (230) receives the data from the client (210).

3. The server (230) processes the data from the client (210) and requests templates, forms, or other material for the document(s) to be generated from the database (240).

4. The database (240) provides the templates, forms, or other material for the document(s) to be generated to the server (230).

5. The server (230) generates the document(s) (incorporating the templates, forms, or other material from the database (240) and the information provided by the client (210)) and transmits (or makes available for download) the document(s).

6. The client (210) downloads or otherwise gets the document(s).

FIG. 3A shows an example server-side system architecture, and FIG. 3B shows example software and hardware for the server-side system architecture of FIG. 3A. The server-side system includes multiple server computers connected with switches or other network equipment. In FIG. 3A, the server computers include one or more Web servers, one or more database servers, and one or more print servers.

The various services of the server-side system are exposed to one or more clients and accessed by the one or more clients through a firewall. The firewall separates the server-side system from the rest of the Internet.

The one or more Web servers (a Web server “cluster” when multiple Web servers are used) render the application interface for various services exposed to clients. As such, much of the interactivity between clients and the server-side architecture is supported through the Web server(s). The Web server(s) also connect to the one or more database servers to retrieve document data, user data, and/or configuration data. The Web server(s) store completed documents in completed document storage.

In some implementations, the number of Web servers is scalable, based on load. When multiple Web servers are used, the system can use load balancing to improve performance. In one implementation, each server of the load-balanced cluster uses Microsoft Windows 2003 Server Enterprise Operating System and Dell/EMC Attached Storage, as well as IIS 6.0 Web Server, Microsoft .NET Framework v1.1, and ASP.NET application with VB.NET core assemblies software.

The one or more database servers (a database server “cluster” when multiple database servers are used) store document data, user data, and configuration data. The database server(s) store such data in attached database storage.

In some implementations, the database servers act as an active/passive SQL database cluster with failover redundancy. In one implementation, each server of the cluster uses Microsoft Windows 2003 Server Enterprise Operating System and Dell/EMC Attached Storage, as well as MS-SQL Server 2000 Enterprise Edition and Microsoft ..NET Framework v1.1 software.

The one or more print servers (a print server “cluster” when multiple print servers are used) are user for document creation. The print server(s) create the final documents for an order.

In some implementations, the number of print servers is scalable, based on load. When multiple print servers are used, the system can use load balancing to improve performance. In one implementation, each server of the cluster uses Microsoft Windows 2003 Server Enterprise Operating System, Microsoft .NET Framework v1.1, ActivePDF Server (for PDF creation), and TRPrintService application (written in VB.NET assemblies) software.

Alternatively, a server-side system includes more or fewer server computers, network nodes, and/or storage nodes. Of course, a server-side system can have a different configuration, and the various server computers can have different roles.

### III. Example Services and Business Processes

Annex A describes various innovative services, business processes, and technical features for document creation and tracking in industries such as real estate, property management (e.g., eviction), securities, and insurance.

In Annex A, the pages entitled, “Who We Are,” “Services,” and “TitleRight, Tomorrow's Documents Today” provide an overview of various services, business processes, and technical features.

In Annex A, the page entitled, “Attorney Services” describes services such as document generation and attorney identity customization for real estate documents, trusts and estates documents, and powers of attorney.

In Annex A, the page entitled, “Lender Services” describes services such as document generation for real estate.

In Annex A, the page entitled, “Property Management/Landlord Services” describes services such as document creation, delivery, and tracking and tenant screening for property management.

In Annex A, the page entitled, “Securities and Insurance Companies” describes services such as document creation, compliance assistance, suitability screening, broker/representative identity customization, and tracking for securities and insurance companies.

In Annex A, the page entitled, “Title Company/Vendor Management” describes document generation and tracking for title and escrow services

In Annex A, the page entitled, “Fees” describes pricing structures for various document creation and tracking services.

Annex B is a published U.S. patent application providing background material on services, business processes, and technical features.

Annex C is a set of screen shots of a client-side user interface for a Web-based service for document creation and tracking.

In Annex C, the screen shot entitled, “Account Administration Menu” shows tabs for four general areas of activity: order queue, document queue, tracking, and account management. The account management tab is expanded, with options for tasks in that area shown. The screen shot entitled, “Manage Client Organizations” shows a user interface for finding or adding a company to an account. The information for a company includes name, address, contact details, and industry as well as account status and representative. The screen shot entitled, “Manage Clients” shows a user interface for finding or adding a user to an account. The information for a user includes name, address, and contact details as well as default user interface configuration, security settings, user status, and password.

In Annex C, the screen shot entitled, “Order Creation” shows a user interface for creating an order of one or more documents. The document queue tab is expanded, and a MN Quitclaim Deed document of the document type Deed in the state of Minnesota has been selected. The screen shot entitled, “Order Queue” shows the MN Quitclaim Deed in a document queue. The screen shot entitled, “Top Down Data Entry” shows examples of fields for a MN Quitclaim Deed, where the fields are populated with data from a bulk upload process or manual data entry by the user. The screen shot entitled, “In Line Data Entry” shows examples of fields for a MN Quitclaim Deed embedded in text for the document. Again, the fields are populated with data from a bulk upload process or manual data entry by the user. The screen shot entitled, “Completed Document” shows a completed document in PDF format, generated from the aggregated data and appropriate template material. The screen shot entitled, “Checkout” shows the MN Quitclaim Deed document as available for later review. Various aspects of document creation processes such as shown in these screen shots are described in more detail in sections IV.A through IV.F.

In Annex C, the screen shot entitled, “Tracking Menu” shows the tracking tab expanded, with options for viewing completed orders and production reports. The screen shot entitled, “Tracking Completed Orders” shows a list of completed orders, which can then be moved to the order queue.

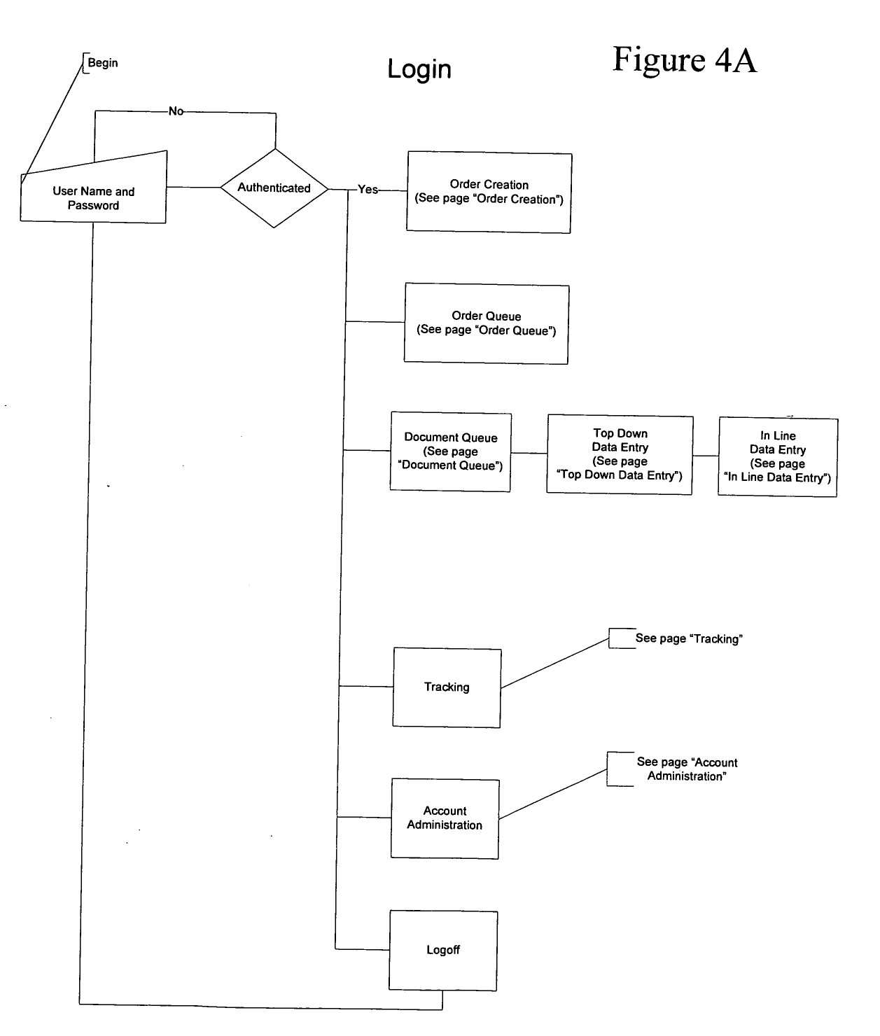

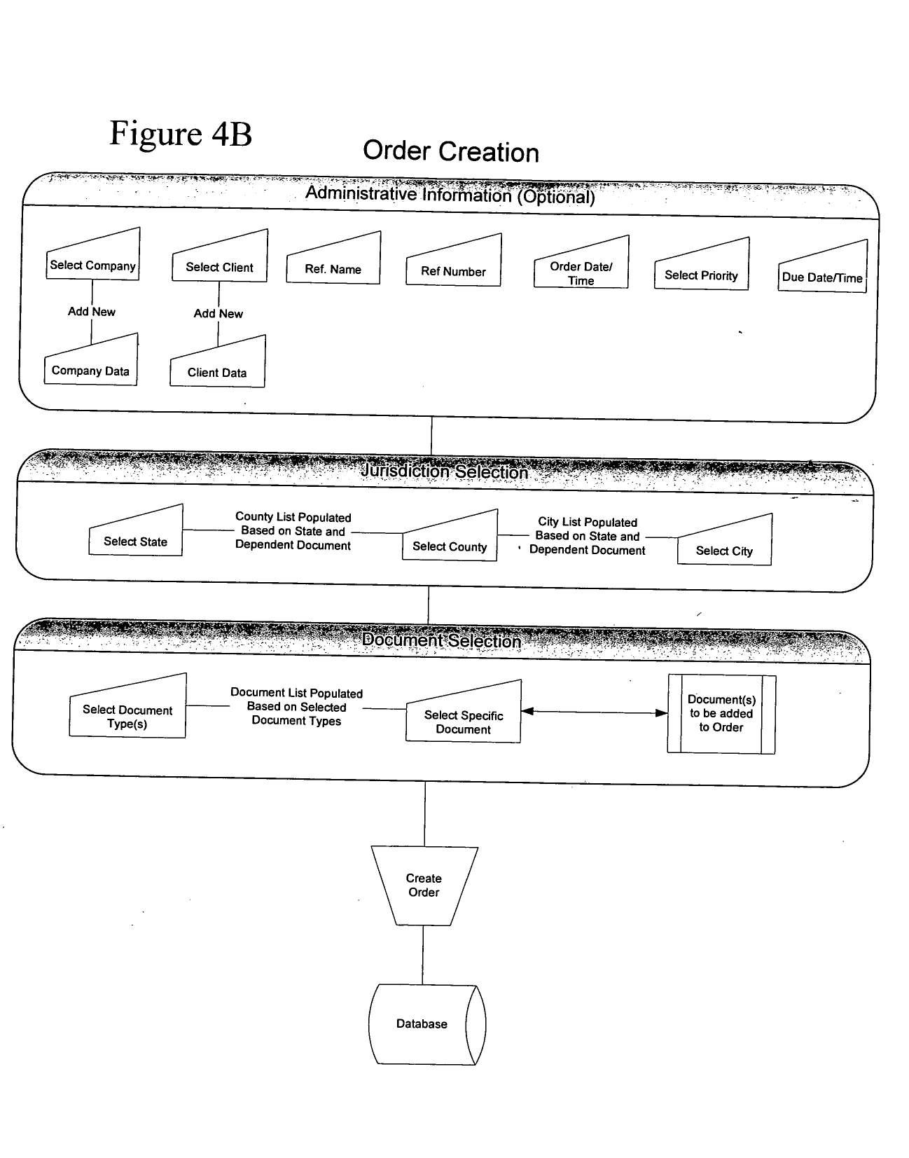

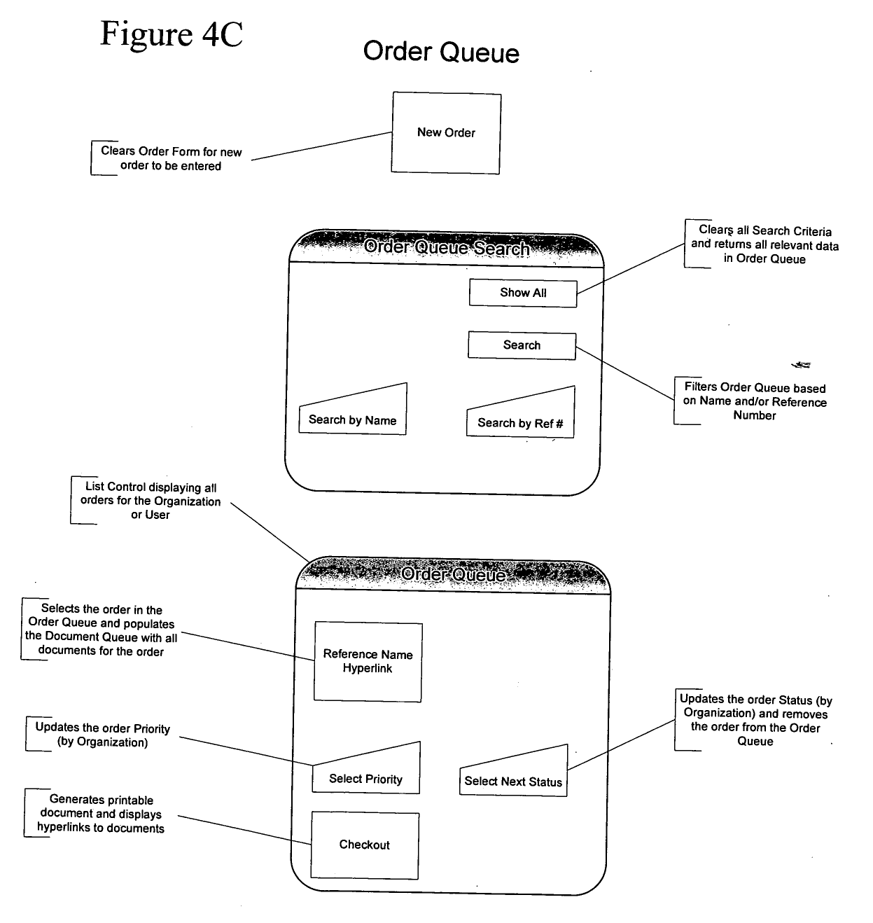

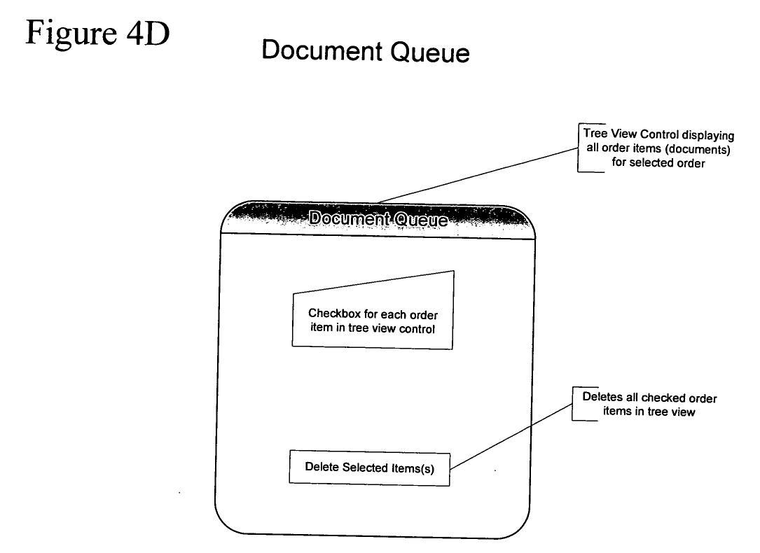

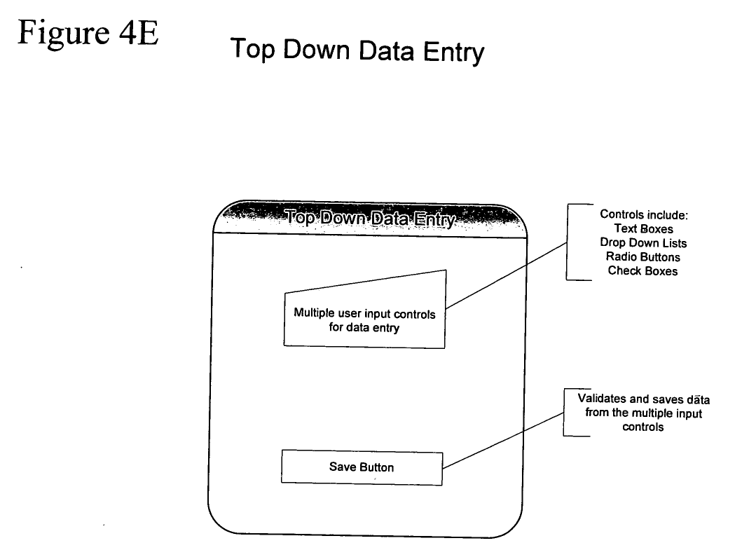

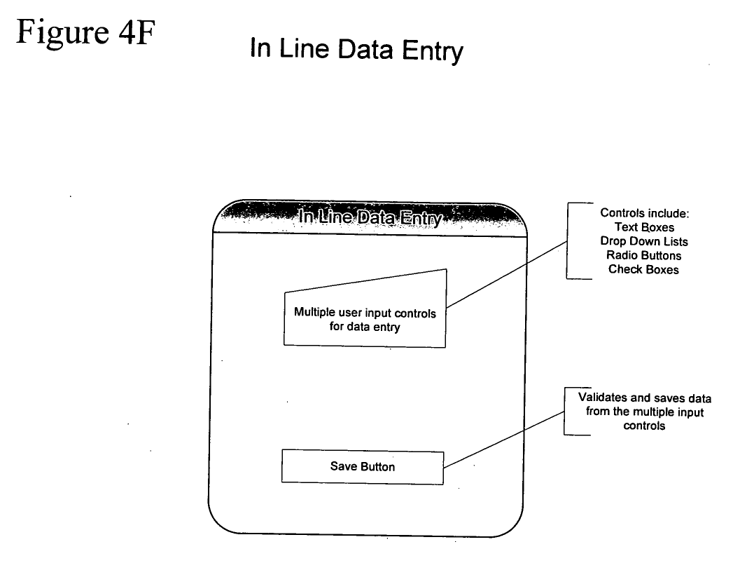

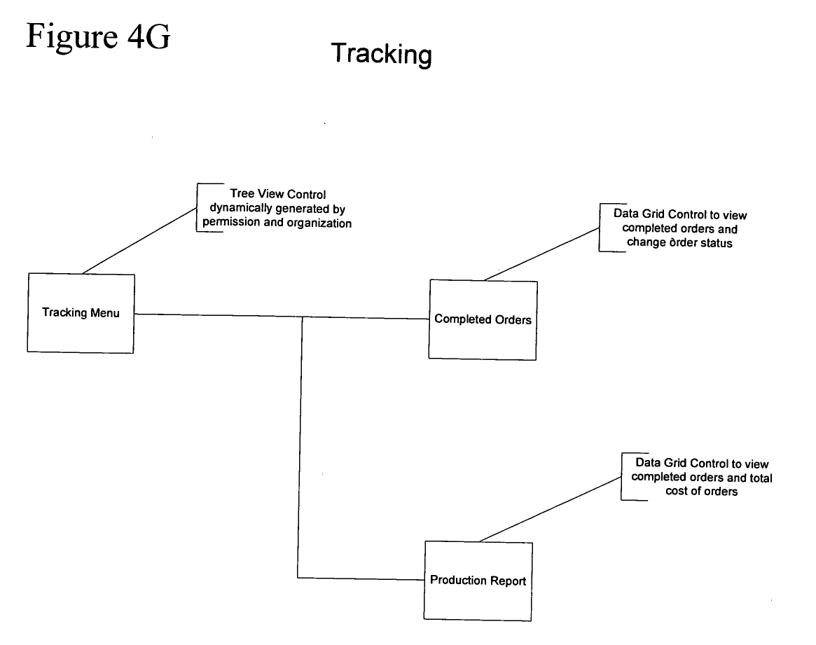

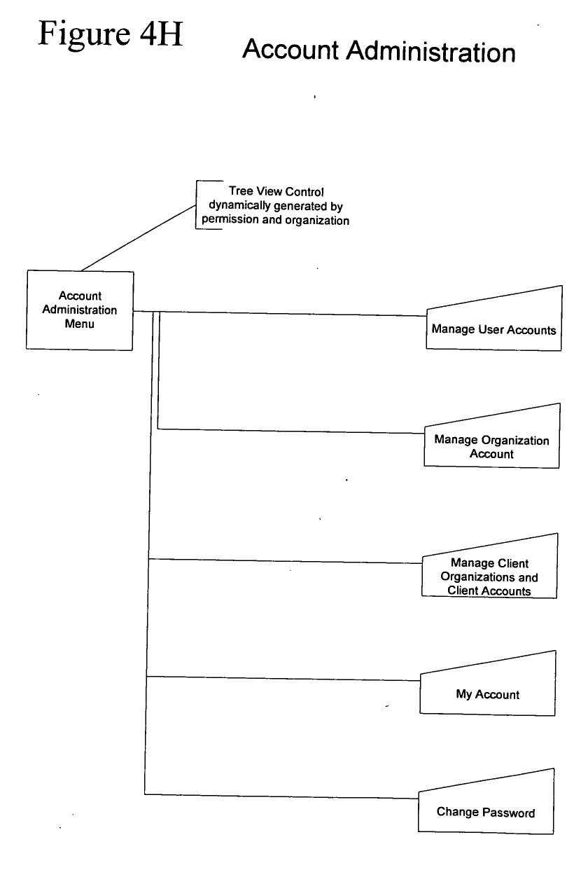

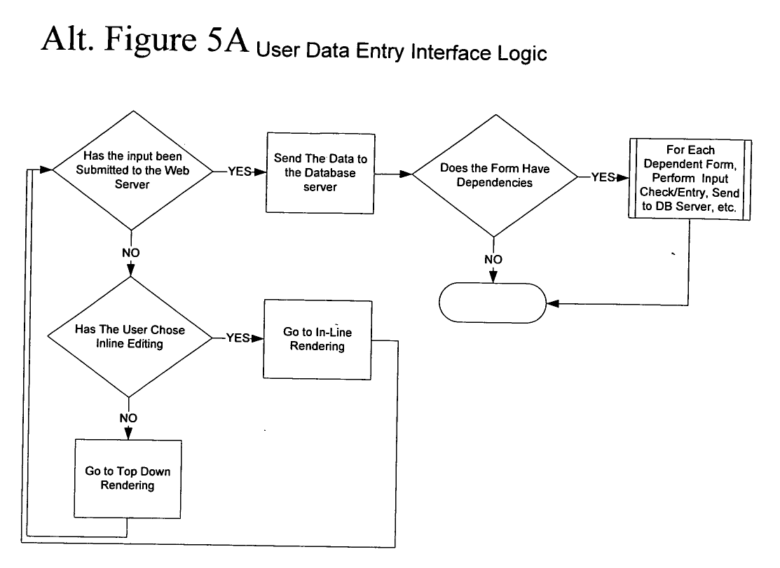

FIGS. 4A through 4H diagram user interface navigation options generally corresponding to those presented in the screen shots of Annex C.

FIG. 4A shows options at a login and top level user interface. After a user provides user name and password for authentication, the user is able to proceed to order creation, an order queue, a document queue, tracking, or account administration, or log off.

FIG. 4B shows user interface navigation options for order creation. The user optionally provides administrative information (e.g., company, client, priority, due date) by selection or addition. The user also provides jurisdiction information and document information by selection or addition. When the user provides jurisdiction information, document information, or other information for one field, the set of options for one or more other fields may change accordingly. For example, when the user selects one level of jurisdiction such as state, the options presented for another level of jurisdiction (such as county) change depending the state selected and/or the dependent documents for the selected state. After providing the information, the user actuates a control to create the order.

FIG. 4C shows user interface navigation options for an order queue. From this point, the user can clear the order form for new orders to be created, search orders by name or reference number, or display orders for a user or organization for further processing. When an order is selected for further processing, the documents for the order are shown in the document queue. The user can then cause the documents to be generated.

FIG. 4D shows user interface navigation options for a document queue. The document queue presents a checkbox for each order item (e.g., document) in a tree view control. The user can then select/deselect order items by actuating the checkboxes.

FIGS. 4E and 4F show user interface navigation options for top down data entry and in-line data entry, respectively. For top down data entry, user input controls (e.g., text boxes, drop down lists, radio buttons, check boxes) are presented to the user for input. For in-line data entry, such user input controls are presented in-line with document context material. The user actuates a save button to save data from the input controls.

FIG. 4G shows user interface navigation operations for tracking. A tree view control is dynamically generated by organization, permission, or some other criterion, presenting items for tracking. For completed orders, for example, a data grid control presents completed orders and options for changing order status. For production reports, for example, a data grid control presents completed orders and cost information.

FIG. 4H shows user interface navigation operations for account administration. Options are presented for managing user accounts, managing organization accounts, managing client organizations and accounts, managing the account of the user logged on, and changing password.

The flow diagrams of FIGS. 4A through 4H and screen shots of Annex C show example user interface organizations and configurations. Alternatively, one or more of the technical features described below are exposed through a different user interface.

### IV. Features

The document generation and processing tools and techniques described herein include numerous innovative features.

A. Bulk Document Processing.

Bulk document processing allows a user to prepare multiple documents as a batch. The user uploads data to a Web-based server, which prepares the documents in a bulk document generation process. Bulk-generated documents can be assignments, reconveyances, releases and/or deeds, among other documents.

For example, if a first bank wants to assign 1,000 loans to a second bank using current software applications, a user prepares one assignment document at a time. Under the bulk processing model, the user uploads the same data set to the server. The server, in turn, analyzes the data and prepares the 1,000 assignments. Compared to a single-document model, the user has the ability to prepare the 1,000 assignments regardless of state or recording jurisdiction at one time, rather than separately constructing the documents one at a time.

When a user opts to use the bulk document processing mode, the server processes specific items in the user's data tables that might affect which documents are generated. Such items include, for example, jurisdiction criteria such as state and county for real estate documents. Or, the server processes other items for generating documents depending on other criteria. The server then prepares the documents based upon the criteria.

The exact mechanics of the data upload process depend on implementation. Annex D, entitled “Bulk Document Data Exporter Instructions,” describes a data exporter used in some implementations. The data exporter shown in Annex D works for a default configuration and document (namely, a NV NTC Deed of Reconveyance). Alternatively, the data exporter is set up to generate another type of document.

In a data export mode, the user sets a date range for the data to be exported, then starts the export process. The data is retrieved and displayed to the user, for example, organized in a spreadsheet as rows of records having fields aligned in columns. The user then sends all or some of the data to the Web-based document generation server.

In a reports mode, the user selects a report and date range, then starts the report generation process. The data for the report(s) is retrieved and displayed to the user, for example, organized in a report as rows of records having fields aligned in columns. The user then prints, searches, exports, zooms in or out, or otherwise processes the report.

B. Single Document Processing

Single document processing is another feature of network-based document generation. Under the single document processing mode, a user logs on to a network-based service (e.g., Website) and selects whatever document they wish to create. For example, the document is a deed, assignment, or other document. The user can narrow a document's criteria by state, county and even city among other things. The user can repeat the single document generation process for one or more other documents as well. Moreover, at various stages the user can reuse information from document to document or provide information to be used in multiple documents, even if the service generates only a single document at a time.

Annex E shows screen shots for a demonstration of a real estate document generation process. The initial screen illustrates an order queue section that shows orders queued for processing, a document queue section that shows orders selected for document generation, and a user information section that shows information about the current user and provides account and session management options.

The initial screen also shows fields for data entry for a new order. The fields include a drop down menu list for client, multiple drop down menu lists for jurisdiction (state, county, and city), and multiple selection lists for document types and documents. For the initial screen and other screens, the exact user interface mechanisms used for data entry depend on implementation, and various combinations of text entry, push buttons, radio buttons, menus, and pick lists can be used. Moreover, data entry fields for other and/or additional information may be present.

The user selects a client from the drop down menu of clients or adds a new client to the list. The user then selects a state, county, and/or city from the respective drop down menu lists.

The user then selects a document type from the document type(s) selection list and actuates the “Get List of Documents” button. The user selects a document from the documents list and actuates the “Add” button. The user repeats these actions for additional documents of the same type or additional documents of different types until the desired documents have been added to the list.

The user then actuates the “Create Order” button to begin building the one or more documents. The document(s) are put in an order queue, and show as an order in the order queue section. When the user selects the order, the document(s) within that order are displayed in the document queue section. The user clicks on the “+” sign to expand and show related documents (related documents are automatically added as dependent documents in some implementations (see below)). The user may then check related document that are not needed and click “delete”.

The user selects the first document to be built and additional data entry fields (if required) appear for additional data entry by the user. The fields are for information such as name and address, and can include required and/or optional fields. To expedite the data entry process, the information for such fields can be provided by a bulk uploading process from one or more sources. A source can be, for example, an ASCII file, XML file, ODBC-compliant data source, or other source. The document generation server imports the uploaded data and seamlessly integrates it into the template, form, or other material for the document(s) to be built. When the user performs manual data entry, fields can be auto-completed based upon previously aggregated data (e.g., previously aggregated data by the same user).

On the screen, the user actuates the “In-Line” button to proceed to the next phase. The user optionally reviews and edits the populated fields of information to be used in the form. The screen arranges information in a document-specific way to facilitate review and editing. For example, the screen shows the entered data placed in text for the document to show the final document in a human readable format. For this and other phases, pop-up balloons can be used to provide prompts for data entry fields.

Once the review/editing process is completed and all required fields are entered, the user actuates a button to cause generation of a completed document from the information that has been aggregated. For example, the document is in a PDF format. The user is then able to review the final generated document.

The final document can be delivered to the user and/or one or more other recipients by an email. Or, the user can simply print the document or save the document as a file in local or remote storage.

C. Real Estate Documents

Real estate documents are one general category of application for the document generation services and tracking described herein. For real estate document generation, the document generation server has within its initial library of documents various real estate related documents such as deeds (e.g., warranty, quitclaim, grant bargain and sale), assignments, releases, reconveyances, and satisfactions, among other documents.

As illustrated by the example in section IV.B, a real estate document can be built to reflect state, county, and/or even city specific requirements.

D. Other Jurisdiction-Specific Forms

In addition to real estate-related documents, the document generation server in some implementations has other state-specific forms, county-specific forms and/or city-specific forms. For example, such forms include a California Preliminary Change of Ownership Report, a Nevada Declaration of Value and a Florida DR-219, among other forms.

These forms are made available in one or more formats. For example, the forms are made available in a PDF format.

In some implementations, one or more of these forms is integrated into the document generation process as a dependent form, as described in section IV.E.

E. Dependent Forms/Documents

In some implementations, the generation of “dependent” forms is integrated into the generation process for other forms. A dependent form is a form that is required or suggested as an accompaniment for some other form. For example, a warranty deed in California requires a California Preliminary Change of Ownership Report to be submitted with the deed at the time of recording.

As such, the network-based server prompts the user to generate the dependent form when the main form is being specified. For example, the generation process for one or more dependent forms is integrated into the document creation process when the main document is selected for creation. At that point or some other point, the user can review which dependent form(s) should be created, deselecting the dependent forms that are not needed. Or, the network-based server automatically generates the dependent form when the main form is specified or built.

F. Web Service & Web Service Client

In some Web-based implementations, a Web-based document creation service through a Web services model allows a user to upload or transmit data to the Web-based server to create documents in a “bulk document exporter” application or other application. The data fields between the data source(s) and the forms are synchronized prior to the data transfers taking place, so as to facilitate the document creation process.

A plug-in application or component can be used to interface between third-party software and/or proprietary software that acts as a data source (e.g., Streamline) and a Web-based document generation server. The interface software, running on a client-side computer or system, thus facilitates synchronization between the data source and the server. This plug-in feature allows a user to parse the data from his native system and provide the data to the Web-based server to create the documents desired.

Also, through a Web Services Definition Language or Web Services Description Language (“WSDL”), a user can view the fields that should be synchronized for correct document creation for the Web-based document creation service.

G. Server-side Architecture and Processes (For Web Services)

In some implementations, the document generation service is designed according to the .NET framework from Microsoft Corporation. In general, .NET is a Web services strategy with associated development tools. With .NET, applications communicate with other applications using a data format such as XML, a messaging protocol such as SOAP, and a registry of services such as one following Universal Description, Discovery, and Integration protocol. In the context of Web-based document generation services, this allows data from different sources to be exposed to other applications (e.g., a document generation server).

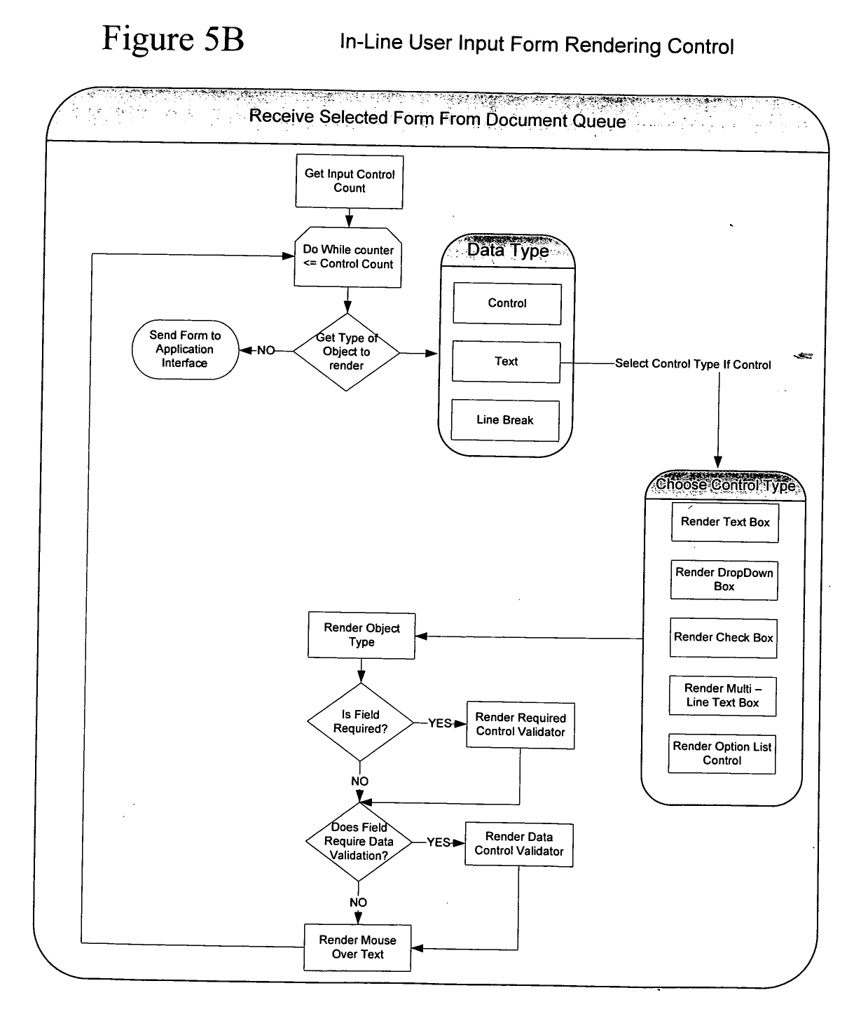

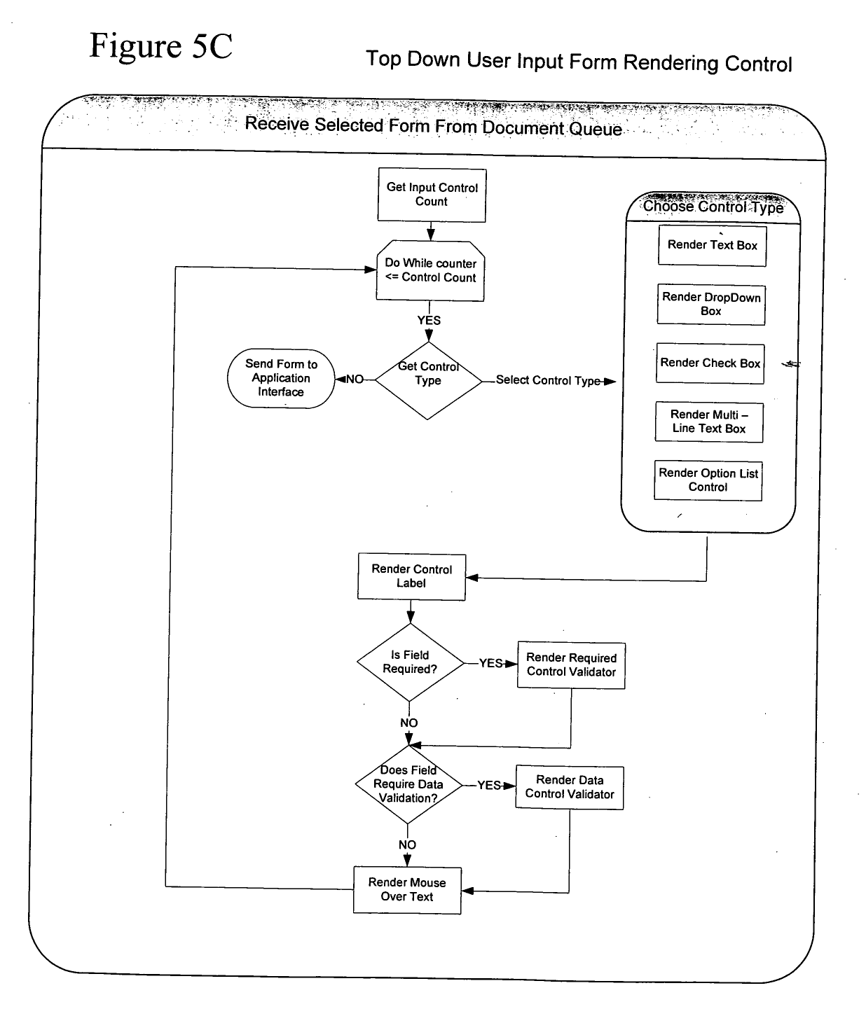

FIGS. 5A through 5C show an example process for user data entry interaction between a Web client and Web server when a document is selected for generation. For example, a Web server such as shown in FIG. 3A performs the Web server acts shown in FIGS. 5A through 5C.

With reference to FIG. 5A, when a document has been selected for generation, the Web server determines if the input for the document has been submitted to the Web server (e.g., by bulk upload). If not, the Web server proceeds to a data entry phase in which the Web server determines (e.g., based on user selection of an editing option) whether to present data entry options to the user in a top down or in line manner.

To create a form for in-line editing (FIG. 5B), the Web server iteratively renders a control for a user input field, document text, or a line break until the form is completed for the document. The control can be, for example, a text box, drop down list, check box, multi-line text box, or option list. The Web server can add information or controls to enforce the presence of required fields, provide data validation, and/or provide prompt text that appears when a mouse cursor hovers over a field. When the form is completed, the form is provided to an application interface for presentation to the Web client.

To create a form for top-down editing (FIG. 5C), the Web server iteratively renders a control for a user input field until the form is completed for the document. The control can be, for example, a text box, drop down list, check box, multi-line text box, or option list. The Web server can add information or controls to enforce the presence of required fields, provide data validation, and/or provide prompt text that appears when a mouse cursor hovers over a field. When the form is completed, the form is provided to an application interface for presentation to the Web client.

Returning to FIG. 5A, when the input has been submitted to the Web server (e.g., by bulk upload or manual entry), the Web server sends the data to a database server for storage of the data.

The Web server then determines if the form has any dependencies. If not, the technique ends. If the form does have dependencies, the Web server repeats the technique for each of the dependent forms, checking whether input has been submitted, rendering a form for data entry if needed, sending data to the database server, checking for further dependencies, etc.

H. Tracking/Searching Engine

In some implementations, a network-based document tracking service tracks documents as they are being created, distributed, and used (e.g., recorded). For example, a tracking engine tracks deeds from creation through distribution and recording.

An indexed tracking database can have fields the same as the fields of the documents tracked (e.g., grantor, grantee, parcel number, among other things). This facilitates tracking and searching the tracking database by various fields. Items from the tracking database can then be downloaded into a user's computer or system for review. The data can be downloaded in a spreadsheet format or some other format.

I. Legal Network

In general, documents generated by the network-based document generation service comply with the guidelines and requirements applicable in the various states, counties, cities, etc. for which the documents are designed. In some implementations, the network-based document generation service provides clients with the option of having generated documents reviewed by licensed attorneys in the appropriate jurisdiction. This feature helps ensure compliance with unauthorized practice of law regulations, where necessary.

J. Securities/Insurance-Related Documents and Generation

In some implementations, a document generation and tracking service is adapted for securities or insurance applications. For example, a securities or insurance interface provides end users with processes for generating some or all of the documents needed in complex insurance or investment/security transactions.

For example, the documents include, but are not limited to, a new client information form, a disclosure form for each product, a rollover and replacement form, a state-mandated replacement form, a product application, and a trustee-to-trustee transfer form. Of course, the documents include other securities and insurance-related forms.

The document generation service can incorporate business rules, regulations, and/or other constraints at various stages. Such constraints are stored in a database, incorporated into field creation in form generation logic, incorporated into dependent form selection logic, enforced by validation of user input, enforced when forms are selected or saved, etc. For example, constraints force representatives and agents to follow the protocol adopted by a company or other organization for a particular transaction type, so as to ensure that required documents are completed prior to a sale. Or, business rules are incorporated in various process stages to help ensure compliance with NASD regulations. Or, business rules are incorporated in various process stages to help ensure that an investment is suitable for a client's needs or risk tolerance.

A broker/dealer, insurance carrier, or other securities or insurance provider can use bulk uploading. The user uploads or otherwise transmits data from his system, avoiding redundant typing and other data entry tasks. To interface between the user's system and the document generation service, a separate customized plug in or application can be written to tie the two applications together and effectuate the data transmission.

When the user manually enters data, redundant data can be pre-populated on selected forms. This reduces data entry errors and also reduces the time required to complete the forms.

Representatives or agents can retain client history in the system for future sales and document generation. This information can be used to draft letters or other correspondence as necessary.

Aside from the representatives or agents handling the paperwork for securities or insurance transactions, the document generation and tracking services provide features to supervising personnel. Such features can be used to track transactions completed by a particular representative or agent, transactions for a particular customer, or transactions of a particular type or in a particular range. For example, federal regulatory compliance officers and/or other personnel at a sales representative's home office can track the real time status of current applications and reports as well as past history. Other features, such as custom tracking options for compliance divisions, can be created and used to monitor the sales history of a representative or agent.

The system can allow electronic transmission of data to a broker/dealer or product provider company from a field representative. For representatives or agents that carry laptops, a disconnected, off-line application can be used that mirrors the interface of the securities/insurance transaction service. This allows the representative or agent to go into a client's home and complete the required information, then log into the service (e.g., on the Web) and upload the data for a transaction.

Thus, securities-related and insurance-related documents are other general categories of applications for the document generation and tracking services described herein. For securities-related or insurance-related document generation, the document generation server has within its initial library of documents various securities-related documents and various insurance-related documents such as those listed above.

Annex F shows screen shots for a demonstration of a securities-related or insurance-related document generation process. The initial screen illustrates an order queue section that shows orders queued for processing, a document queue section that shows orders selected for document generation, and a user information section that shows information about the current user and provides account and session management options.

The initial screen also shows fields for data entry for a new order. The fields include a drop down menu list for client, a drop down list for advisor or representative, and a drop down menu list for broker/dealer. The screen also shows drop down menu lists for transaction type, company, and state, as well as a selection list for documents. For the initial screen and other screens, the exact user interface mechanisms used for data entry depend on implementation, and various combinations of text entry, push buttons, radio buttons, menus, and pick lists can be used. Moreover, data entry fields for other and/or additional information may be present.

The user selects a client from the drop down menu of clients or adds a new client to the list. To simplify data entry or enforce compliance with a rule, an advisor can enter client history information (including financial data) at this stage, or a compliance division can make providing such data mandatory before selecting any forms.

The user selects an advisor or representative from the drop down menu of advisors/representatives or adds a new advisor/representative to the list. The user also selects or adds a broker/dealer. In some implementations, upon selection of an advisor/representative, the items that will be listed in the drop down menu list for broker/dealer are adjusted to show only the brokers/dealers for whom the advisor/representative can write business. Or, all brokers/dealers are shown, but the user can only select a broker/dealer for whom the advisor/representative can write business. The broker/dealer selections available to the user are thus limited depending on the advisor/representative selection made.

The user then selects a transaction type or types from the transaction type drop down menu. Example transaction types include mutual fund, life insurance, stock, and variable annuity.

The user selects the company for the documents to be generated and selects a state (for state-specific forms). In some implementations, upon selection of an advisor/representative, the items that will be listed in the drop down menu list for state are adjusted to show only the states for which the advisor/representative can write business. Or, all states are shown, but the user can only select a state for which the advisor/representative can write business. The state selections available to the user are thus limited depending on the advisor/representative selection made.

The user then selects a document from the documents list and actuates the “Add” button. The user repeats these actions for additional documents of the same type or different types until the desired documents have been added to the list. Sub-lists of other types of documents may be presented to the user for selection.

The user then actuates the “Create Order” button to begin building the one or more documents. The document(s) are put in an order queue, and show as an order in the order queue section. When the user selects the order, the document(s) within that order are displayed in the document queue section. The user clicks on the “+” sign to expand the amount of detail shown for a particular document, e.g., the different components of the document. The user may then check/uncheck parts of the document that are needed/not needed.

The user selects the first document to be built and additional data entry fields (if required) appear for additional data entry by the user. The fields are for information such as name and address, and can include required and/or optional fields. To expedite the data entry process, the information for such fields can be provided by a bulk uploading process from one or more sources. A source can be, for example, an ASCII file, XML file, ODBC-compliant data source, or other source. The document generation server imports the uploaded data and seamlessly integrates it into the template, form, or other material for the document(s) to be built. When the user performs manual data entry, fields can be auto-completed based upon previously aggregated data (e.g., previously aggregated data by the same advisor/representative or broker/dealer).

On the screen, the user actuates the “Review/Edit” button to proceed to the next phase. The user optionally reviews and edits the populated fields of information to be used in the form. The screen arranges information in a document-specific way to facilitate review and editing. For example, the screen shows the entered data placed in text for the document to show what the final document will look like. For this and other phases, pop-up balloons can be used to provide prompts for data entry fields.

Once the review/editing process is completed, the user actuates a button to cause generation of a completed document from the information that has been aggregated. For example, the document is in a PDF format. The user is then able to review the final generated document.

The final document can be delivered to the user and/or one or more other recipients by an email. Or, the user can simply print the document or save the document as a file in local or remote storage.

Annex G shows a screen shot for a general information form for securities-related documents.

Annex J provides additional description about innovations in this area.

K. Property Management-Related Documents and Generation

In some implementations, a document generation and tracking service is adapted for property management applications. For example, an eviction forms interface provides end users with processes for generating some or all of the documents needed to evict a tenant. The eviction process typically begins with an initial notice and is completed when the tenant is evicted and all monies are collected.

For example, initial notices of delinquency are bulk processed and printed for physical delivery to a residence. An additional copy is also generated along with the Proof of Mailing sheet for mailing the notices to the tenants. Other aspects include form completion for forms such as 3-day notices, 5-day quit or pay rent notices, USPS Certificate of Mailing forms, property management forms and reports, lease renewal forms, and other eviction forms. Alternatively, the service is used for other property management forms.

The document generation service may use any of several mechanisms to reduce the burdens of data entry. The document generation server can accept data via bulk upload of tenant information through a Web service or other mechanism. Or, when multiple tenants have the same information for the documents to be generated, the information can simply be repeated for the different tenants or multiple tenants can be selected for the same information. Alternatively, tenant information is entered singly.

For example, the document generation service can interface with “CourtView” software or other Constable or legal system software to reduce data entry burdens for tenants that are evicted. By facilitating electronic filing of evictions-related documents, costs due to printing documents are avoided. The labor costs of delivering paper between the property management company, court and process server are reduced as well.

In some implementations, the document generation service considers account information for tenants. For example, account balance and payment information are input to the service, or such information is exposed to the service from an accounting system, as tenants pay or do not pay their delinquent balances. Going forward, tenants with a balance after a specified period of time are displayed for subsequent documents (e.g., formal eviction notices) to be generated. After the formal eviction process is complete, data can be downloaded and forwarded to a collection company.

The service provides various document tracking features as described above for real estate documents. These include tracking as documents are created, distributed, and used (e.g., recorded). An indexed tracking database can have fields the same as the fields of the documents tracked. This facilitates tracking and other searching the tracking database by various fields. The tracking features also include report generation features.

Aside from document tracking during the eviction process for particular tenants, the document generation and tracking service can be integrated with custom or third-party software such as “rent roll” software used by property management companies to track tenant history. Or, the service can be integrated with such software to share accounting information or share information for other forms.

The document generation and tracking service can allow property managers or other subscribers to search the database by name, address, or other information. For example, when eviction notices are not in the public record, as part of a screening process, a property manager or other subscriber uses this feature to check whether a particular prospective tenant has recently been served an eviction notice. This can help the property manager or other subscriber make an informed decision about the prospective tenant. Thus, before renting a new apartment to a tenant who is avoiding rent payments for an old apartment, the property manager or other subscriber has the information needed to make an informed decision, so long as data for the old apartment is in the system.

In some Web-based implementations, a property management company that manages properties in multiple cities or states can access the system in real time. The property management company can perform current status checks on all tenants through the eviction notice process and eviction process. Data from the document generation and tracking system can be downloaded back to the systems of the property management company if necessary.

Thus, property management-related documents are another general category of application for the document generation and tracking services described herein. For property management-related document generation, the document generation server has within its initial library of documents various property management-related documents.

Annex H shows a screen shot for a demonstration of an eviction-related document generation process. The screen illustrates an order queue section that shows orders queued for processing, a document queue section that shows orders selected for document generation, a tracking section, and an account administration section that shows information about the current user and provides account and session management options.

The initial screen also shows fields for data entry for a new order. The fields include a drop down menu list for the type of eviction form and a check box list for clients. For the screen, the exact user interface mechanisms used for data entry depend on implementation, and various combinations of text entry, push buttons, radio buttons, menus, and pick lists can be used. Moreover, data entry fields for other and/or additional information may be present.

The user selects a type of eviction form from the drop down menu of eviction forms. The user selects one or more clients from the client list and/or adds one or more clients to the client list. The user optionally adds or edits information such as physical address and email address.

The user then actuates the “Create Order” button to begin building the one or more documents. The document(s) are put in an order queue, and show as an order in the order queue section. When the user selects the order, the document(s) within that order are displayed in the document queue section. The user clicks on the “+” sign to expand the amount of detail shown for a particular document, e.g., the different components of the document. The user may then check/uncheck parts of the document that are needed/not needed.

The user selects the first document to be built and additional data entry fields (if required) appear for additional data entry by the user. The fields can include required and/or optional fields. To expedite the data entry process, the information for such fields can be provided by a bulk uploading process from one or more sources. A source can be, for example, an ASCII file, XML file, ODBC-compliant data source, or other source. The document generation server imports the uploaded data and seamlessly integrates it into the template, form, or other material for the document(s) to be built. When the user performs manual data entry, fields can be auto-completed based upon previously aggregated data (e.g., previously aggregated data by the same user).

The user actuates the “Review/Edit” button to proceed to the next phase. The user optionally reviews and edits the populated fields of information to be used in the form. The screen arranges information in a document-specific way to facilitate review and editing. For example, the screen shows the entered data placed in text for the document to show what the final document will look like. For this and other phases, pop-up balloons can be used to provide prompts for data entry fields.

Once the review/editing process is completed, the user actuates a button to cause generation of a completed document from the information that has been aggregated. For example, the document is in a PDF format. The user is then able to review the final generated document.

The final document can be delivered to the user and/or one or more other recipients by an email. Or, the user can simply print the document or save the document as a file in local or remote storage.

Annex J provides additional description about innovations in this area.

L. Form Maintenance/Generation Program

In some implementations, form maintenance/generation software is used to specify and maintain the fields, field prompts, data validation requirements, field type requirements, in-line text, etc. for the various forms provided as part of a document generation service.

For example, in one implementation, the form maintenance/generation software is termed the TR Manager software. The TR Manager software is used to synchronize the relationships between databases (storing form data, user data, configuration data), dynamic Web-based forms, and the actual report documents. The TR Manager software also accepts text and the data required to generate forms for in-line data entry and reviewing Web forms.

Annex I shows screen shots for specifying or editing information for a form for a document. The “Forms” tab screen shot shows a selection list of forms, with the AK Affidavit of Identity currently selected. The form name, file name for the XML definition, document type, and state (or other jurisdiction) may be set from this tab. Actions from this tab include copying a document, adding a new document, updating a document, deleting a document, and creating an XML schema (“XSD”) for a form. The “Form Fields” tab screen shot shows a spreadsheet in which various information about fields (e.g., placement in the document, required/optional designation, field name, type of data entry, field size, prompt text information, etc.) can be added, edited, or removed. The “Inline” tab screen shot shows a version of the form with field information for the document interleaved with text for the document, thus showing the placement of the fields and text for the form.

The in-line data entry form generation is specific to the document generation services described herein. It uses a data table relation to bind form fields, and ASCII codes and text to generate the form.

M. Dynamic Form Render Control

In some implementations, a form is generated by querying a database for the form field definitions for the form. For example, the form is identified based on a FormID, corresponding to a selection by the user from the document queue.

FIGS. 5B and 5C show examples of dynamic form rendering in some implementations. An HTML form is generated by iterating through the relevant definitions and rendering the proper HTML control based on form field type. For an In-Line form (FIG. 5B), additional material such as text and/or line breaks is also rendered. For a Top-Down form (FIG. 5C), each HTML control also receives a label. Additionally, each control can include client-side Javascript or other script or executable code for validation that required fields are present and/or validation that data types are correct for fields (e.g., numeric, text, etc.). Upon successfull validation (or simply upon completion when no validation is used), the class saves the data to the database.

N. Print Engine

In some implementations, the document generation service uses a print engine to generate final documents in a final document format from data and a report template. For example, the final document format is PDF, the report template is dynamically generated, and the data is provided by the user or some other mechanism. Alternatively, the service uses another final document format and/or generates report templates using some other technique.

The print engine can run on a host server (along with a Web server). Or, it can run on a separate server as part of a distributed server system.

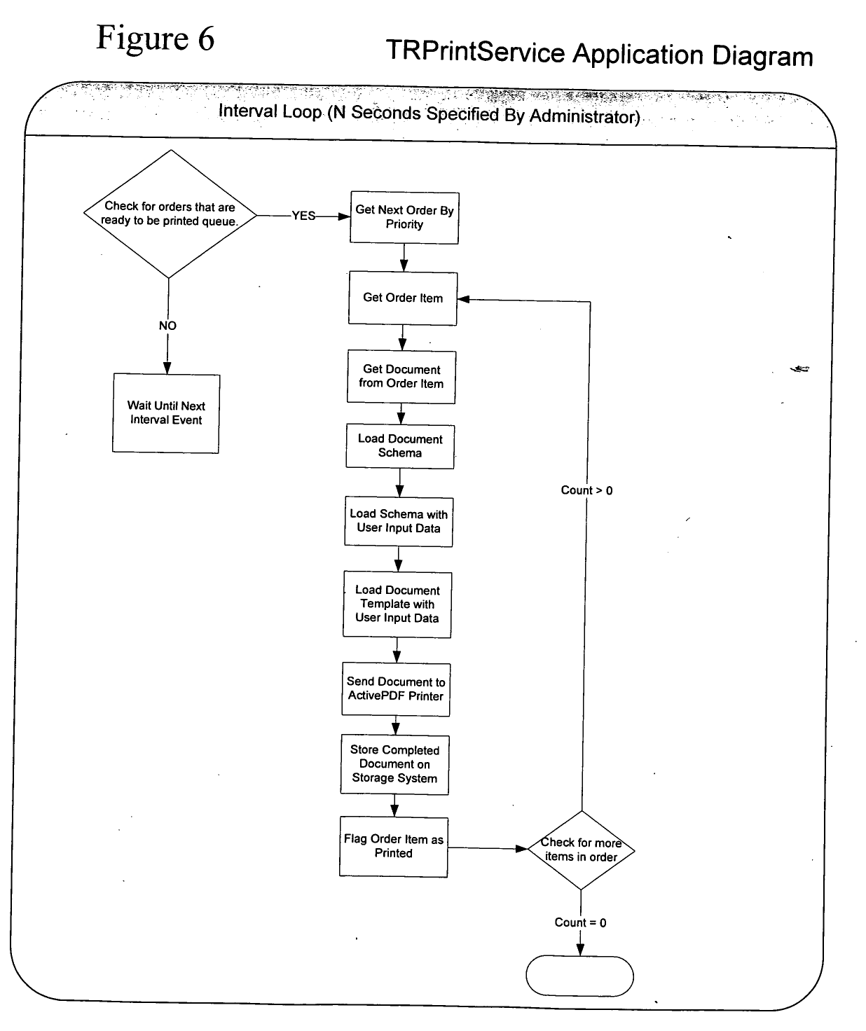

FIG. 6 shows an example process for final document completion. According to FIG. 6, the print engine is an n-tiered application that generates PDF files with data from a database formatted by a report template.

The application monitors a database for the main application. When a user requests a final document, a flag is set indicating that orders are ready to be “printed” (here, put in the final document format, not necessarily put on paper).

Orders are sorted by priority and segregated into individual order items (e.g., documents). Thus, for example, the print engine starts with the highest priority order in the queue of orders to be printed. The print engine then iteratively processes the order items (e.g., documents) for that order.

For a particular document, the print engine loads the document schema into memory and loads user input data against the schema. The document schema and user input data are then loaded into the document template.

The document template is sent to a 3^{rd} party application (e.g., Active PDF Printer) to generate the PDF file for the document. The PDF is then saved, and the order is flagged in the database as “printed.”

The print engine repeats the generation process for other order items in the order. When the order is completed, the application continues to monitor the database for other pending jobs.

Alternatively, one or more acts of the final document generation process are combined with other acts or replaced with analogous acts. More generally, the various acts of the techniques described herein may in many cases be combined with other acts, split into multiple acts, skipped, or replaced with analogous acts.

### ANNEXES

The following materials are submitted as Annexes.

Annex A (15 pages): Web page printouts. These Web page printouts from www.titleright.com explain various innovative services, business processes, and technical features.

Annex B (11 pages): U.S. Patent Application Publication No. US 2004/0010451, entitled “Method and System for Finalizing Specific Processes Through a Dynamic System.” This published patent application describes, among other things, example business processes and user interface navigation techniques for a document generation and processing service.

Annex C (11 pages): “TitleRight” screen shots. These Web page printouts from www.titleright.com explain various innovative services, business processes, and technical features.

Annex D (8 pages): User manual entitled, “Bulk Document Data Exporter Instructions.” This user manual describes a data exporter used in some implementations.

Annex E (46 pages): Product demonstration entitled, “Welcome to TitleRight Version 2.0 Demo.” These screen shots show a product demonstration of TitleRight Version 2.0 for generation of real-estate documents.

Annex F (46 pages): Product demonstration entitled, “Welcome to TitleRight Version 2.0 Demo.” These screen shots show a product demonstration of TitleRight Version 2.0 for generation of securities/insurance documents.

Annex G (1 page): “Securities Client Entry Form” screen shot.

Annex H (1 page): “Eviction Order Creation” screen shot.

Annex I (3 pages): “TitleRight Manager” screen shots. These screen shots show a user interface for form specification.

Annex J (12 pages): Draft patent application entitled, “SYSTEM AND METHOD FOR ELECTRONIC MANAGEMENT AND FORM DISTRIBUTION.” This patent application describes innovative aspects of generating, distributing, managing, tracking, storing and otherwise processing forms and other documents, for areas including securities transactions, insurance transactions, property management (e.g., eviction forms), and real estate.

In view of the many possible embodiments to which the principles of the disclosed invention may be applied, it should be recognized that the illustrated embodiments are only preferred examples of the invention and should not be taken as limiting the scope of the invention.

1. A method, comprising:
with a document generation service, performing bulk document processing.

2. The method of claim 1 wherein the service is provided as a Web service.

3. The method of claim 1 wherein the bulk document processing include a bulk data uploading process.

4-10. (canceled)

11. A method comprising:
with a document generation service, generating securities-related documents.

12. The method of claim 11 wherein the service is a Web service.

13. A method comprising:
with a document generation service, generating insurance-related documents.

14. The method of claim 13 wherein the service is a Web service.

15-20. (canceled)
